(19) United States
(12) Patent Application Publication
(10) Pub. No.: US 2023/0182100 A1
(43) Pub. Date: Jun. 15, 2023

(54) DEHYDROGENATION REACTION APPARATUS AND CONTROL METHOD THEREOF

(71) Applicants: HYUNDAI MOTOR COMPANY, Seoul (KR); KIA CORPORATION, Seoul (KR); KOREA INSTITUTE OF SCIENCE AND TECHNOLOGY, Seoul (KR)

(72) Inventors: Yongwoo Kim, Gunpo-si (KR); Jihui Seo, Ulsan (KR); Jaeyong Lee, Seongnam-si (KR); Pyung Soon Kim, Suwon-si (KR); Jin Woo Choung, Suwon-si (KR); Minkyu Kim, Seoul (KR); Jaewon Kirk, Seoul (KR); Suk Woo Nam, Seoul (KR); Hyangsoo Jeong, Seoul (KR); Yongmin Kim, Seoul (KR)

(73) Assignees: HYUNDAI MOTOR COMPANY, Seoul (KR); KIA CORPORATION, Seoul (KR); KOREA INSTITUTE OF SCIENCE AND TECHNOLOGY, Seoul (KR)

(21) Appl. No.: 17/874,631

(22) Filed: Jul. 27, 2022

(30) Foreign Application Priority Data
Dec. 13, 2021 (KR) 10-2021-0177574

(51) Int. Cl. B01J 7/00; C01B 3/00

(52) U.S. Cl. CPC B01J 7/00; C01B 3/0005; C07B 35/04

(57) ABSTRACT

A dehydrogenation reaction apparatus is disclosed. An embodiment of the present disclosure provides a dehydrogenation reaction apparatus, including: a dehydrogenation reactor that includes a reaction vessel configured to store a chemical hydride, and at least one partition wall partitioning an inner space of the reaction vessel into a plurality of reaction chambers; and a buffer tank configured to temporarily store hydrogen generated in the dehydrogenation reactor and then supply the hydrogen to the fuel cell.

### CROSS-REFERENCE TO RELATED APPLICATION

This application claims priority to and the benefit of Korean Patent Application No. 10-2021-01 77574 filed in the Korean Intellectual Property Office on Dec. 13, 2021, the entire contents of which are incorporated herein by reference.

### BACKGROUND

### (a) Field

The present disclosure relates to a dehydrogenation reaction apparatus and a control method thereof that may supply hydrogen to a fuel cell stack.

### (b) Description of the Related Art

Due to depletion of fossil energy and environmental pollution problems, there is a great demand for renewable and alternative energy, and hydrogen is attracting attention as one of such alternative energies.

A fuel cell and a hydrogen combustion device use hydrogen as a reaction gas, and in order to apply the fuel cell and the hydrogen combustion device to vehicles and various electronic products, a stable and continuous supply technology of hydrogen is required.

In order to supply hydrogen to a device that uses hydrogen, a method of being supplied with hydrogen whenever hydrogen is needed from a separately installed hydrogen supply source may be used. In this way, compressed hydrogen or liquefied hydrogen may be used.

Conventionally, in order to supply hydrogen to a fuel cell or a hydrogen combustion device, an acid aqueous solution is injected into a hydride stored in a reaction vessel to generate hydrogen, and in this case, a product and a reactant are mixed in the reaction vessel.

No problem occurs during the reaction between the hydride and the acid aqueous solution in the reaction vessel, but when the reaction between the hydride and the acid aqueous solution is temporarily stopped and restarted, a solidified product (for example, a sodium (Na) product) interferes with the reaction between the hydride and the acid aqueous solution, and due to this, a hydrogen conversion rate of the hydride may be lowered.

The above information disclosed in this Background section is only for enhancement of understanding of the background, and therefore it may contain information that does not form the prior art that is already known in this country to a person of ordinary skill in the art.

### SUMMARY

The present disclosure has been made in an effort to provide a dehydrogenation reaction apparatus and a control method thereof that may improve a hydrogen conversion rate of a hydride in a dehydrogenation reactor when a reaction between the hydride and an acid aqueous solution is temporarily stopped and restarted in the dehydrogenation reactor.

An embodiment of the present disclosure provides a dehydrogenation reaction apparatus, including: a dehydrogenation reactor that includes a reaction vessel configured to store a chemical hydride, and at least one partition wall partitioning an inner space of the reaction vessel into a plurality of reaction chambers; and a buffer tank configured to temporarily store hydrogen generated in the dehydrogenation reactor and then supply the hydrogen to the fuel cell.

In the dehydrogenation reactor, a first supply port formed in the reaction vessel to supply an acid aqueous solution to each of the reaction chambers partitioned by the partition wall, a second supply port formed in the reaction vessel to supply a chemical hydride to each of the reaction chambers partitioned by the partition wall, and a gas outlet formed in the reaction vessel to discharge hydrogen generated in each of the reaction chambers, may be formed.

The dehydrogenation reaction apparatus may further include a cooling coil installed inside the reaction vessel to circulate a refrigerant.

The dehydrogenation reaction apparatus may further include a back pressure regulator disposed between the dehydrogenation reactor and the buffer tank.

The dehydrogenation reaction apparatus may further include a mass flow meter disposed between the buffer tank and the fuel cell.

The dehydrogenation reaction apparatus may further include: an acid aqueous solution tank configured to store an acid aqueous solution; and a pump configured to pump an acid aqueous solution stored in the acid aqueous solution tank to the dehydrogenation reactor.

The dehydrogenation reaction apparatus may further include a controller configured to adjust an acid aqueous solution supplied to the dehydrogenation reactor based on a use rate of hydrogen consumed in a fuel cell and an inner pressure of the buffer tank.

Only when the inner pressure of the buffer tank is less than a reference pressure, the controller may supply an acid aqueous solution to the dehydrogenation reactor.

When the use rate of the hydrogen consumed in the fuel cell is less than or equal than a generation rate of hydrogen generated in the reaction chamber, the controller may supply an acid aqueous solution to one reaction chamber.

When the use rate of the hydrogen consumed in the fuel cell exceeds the generation rate of the hydrogen generated in the reaction chamber, the controller may supply an acid aqueous solution to a plurality of reaction chambers.

An amount of hydrogen stored in the buffer tank may be set to be equal to a total amount of hydrogen generated in one reaction chamber.

Another embodiment provides a control method of a dehydrogenation reaction apparatus. The method includes: measuring an inner pressure of a buffer tank; comparing a use rate of hydrogen consumed in the fuel cell with a generation rate of hydrogen generated in one reaction chamber when the inner pressure of the buffer tank is less than a reference pressure; and supplying an acid aqueous solution to one reaction chamber or a plurality of the reaction chambers based on the use rate of the hydrogen and the generation rate of the hydrogen.

When the use rate of the hydrogen is less than or equal to the generation rate of the hydrogen, an acid aqueous solution may be supplied to one reaction chamber.

When the use rate of the hydrogen exceeds the generation rate of the hydrogen, an acid aqueous solution may be supplied to the plurality of the reaction chambers.

An acid aqueous solution may be supplied until all chemical hydrides stored in the reaction chamber react.

According to the dehydrogenation reaction apparatus and the control method thereof according to the embodiment as described above, by reacting all hydrides stored in one of a plurality of reaction chambers partitioned by a partition wall, it is possible to maintain a hydrogen conversion rate of the hydride at a high level.

In addition, by introducing a buffer tank for temporarily storing hydrogen generated in a dehydrogenation reactor, it is possible to stably supply hydrogen to a fuel cell.

### BRIEF DESCRIPTION OF THE DRAWINGS

These drawings are for reference only in describing embodiments of the present disclosure, and therefore, the technical idea of the present disclosure should not be limited to the accompanying drawings.

FIG. 1 illustrates a perspective view of a dehydrogenation reaction apparatus according to an embodiment.

FIG. 2 illustrates a schematic view of a dehydrogenation reaction apparatus according to an embodiment.

FIG. 3 illustrates a perspective view of a dehydrogenation reactor according to an embodiment.

FIG. 4 illustrates a cross-sectional view of a dehydrogenation reactor according to an embodiment.

FIG. 5 illustrates a flowchart of a control method of a dehydrogenation reaction apparatus according to an embodiment.

### DETAILED DESCRIPTION OF THE EMBODIMENTS

The present disclosure is described with reference to the accompanying drawings, in which embodiments of the disclosure are shown. As those skilled in the art would realize, the described embodiments may be modified in various different ways, all without departing from the spirit or scope of the present disclosure.

In order to clearly describe the present disclosure, parts that are irrelevant to the description are omitted, and identical or similar constituent elements throughout the specification are denoted by the same reference numerals.

In addition, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

Hereinafter, a dehydrogenation reaction apparatus according to an embodiment is described in detail with reference to the accompanying drawings.

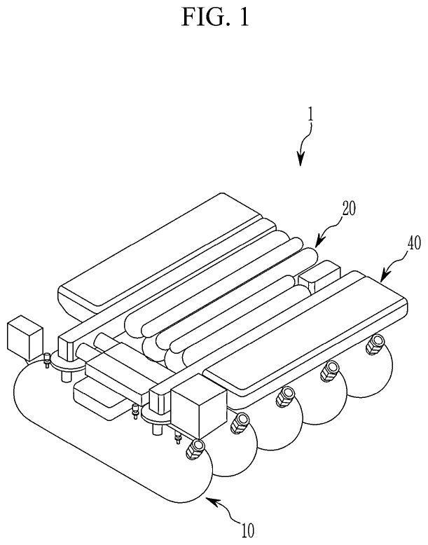

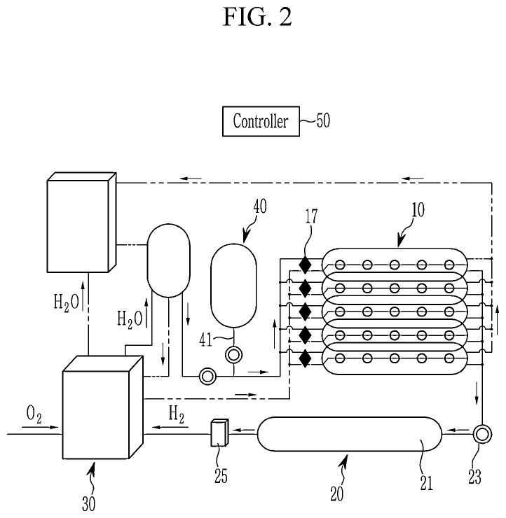

FIG. 1 illustrates a perspective view of a dehydrogenation reaction apparatus according to an embodiment. FIG. 2 illustrates a schematic view of a dehydrogenation reaction apparatus according to an embodiment.

As shown in FIG. 1 and FIG. 2, an embodiment of the dehydrogenation reaction apparatus 1 may include a dehydrogenation reactor 10 that generates hydrogen by reaction of a chemical hydride with an acid aqueous solution, a buffer tank 20 that temporarily stores the hydrogen generated in the dehydrogenation reactor 10, and an acid aqueous solution tank 40 that stores the acid aqueous solution supplied to the dehydrogenation reactor 10.

The dehydrogenation reactor 10 may be configured as a high-temperature and high-pressure vessel so that the dehydrogenation reaction may be performed under a high-temperature and high-pressure condition. For example, the dehydrogenation reactor 10 may have a cylindrical, spherical, rectangular parallelepiped, or polygonal prism shape. In one particular embodiment, the dehydrogenation reactor 10 may have a cylindrical shape.

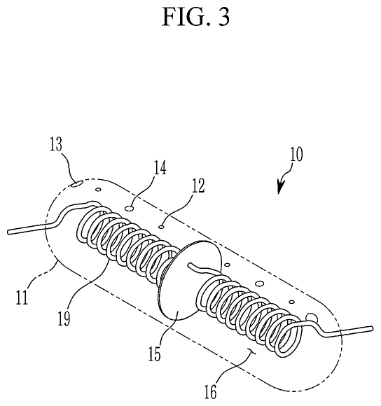

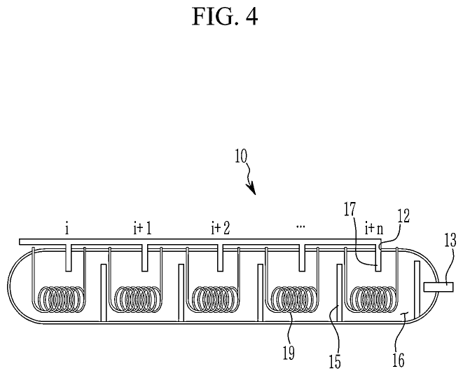

Referring to FIG. 3 and FIG. 4, the dehydrogenation reactor 10 may include a reaction vessel 11 of which inside is empty, and at least one partition wall 15 partitioning an inner space of the reaction vessel 11 into a plurality of reaction chambers 16.

A first supply port 12 is formed in the reaction vessel 11 so as to supply an acid aqueous solution to each reaction chamber 16 partitioned by the partition wall 15, a second supply port 13 is formed in the reaction vessel 11 so as to supply a chemical hydride to each reaction chamber 16 partitioned by the partition wall 15, and a gas outlet 14 through which hydrogen generated in each reaction chamber 16 is discharged is formed in the reaction vessel 11. For example, when one partition wall 15 is formed in the reaction vessel 11 so that two reaction chambers 16 are formed inside the reaction vessel 11, two first supply ports 12 and two second supply ports 13 may be formed, and one gas outlet 14 may be formed.

The first supply port 12 and the acid aqueous solution tank 40 are fluidly connected so as to supply an acid aqueous solution to the reaction chamber 16 through the first supply port 12. A detailed description of the acid aqueous solution tank 40 is described below.

The chemical hydride supplied through the second supply port 13 may be supplied into the reaction chamber 16 in a form of powder. For example, the chemical hydride may be filled in the form of powder in the reaction chamber 16 of the reaction vessel 11 at a gas station. The chemical hydride supplied to each reaction chamber 16 is supplied by a set amount through the second supply port 13, and for example, the hydride may be supplied to each reaction chamber 16 at about 0.5 to 3 kg.

The chemical hydride is in a solid state, and for example, may be in a form of one of powder, granular, beads, microcapsules, and pellets.

The chemical hydride may be a compound that is hydrolyzed to produce hydrogen and a hydrolyzate. In certain examples, the chemical hydride may include sodium borohydride (NaBH₄), lithium borohydride (LiBH₄), potassium borohydride (KBH₄), ammonium borohydride (NH₄BH₄), ammonia borane (NH₃BH₃), tetramethyl ammonium borohydride ((CH₃)₄NH₄BH₄), sodium aluminum hydride (NaAlH₄), lithium aluminum hydride (LiAlH₄), potassium aluminum hydride (KAlH₄), calcium borohydride (Ca(BH₄)₂), magnesium borohydride (Mg(BH₄)₂), sodium tetrahydridogallate (NaGaH₄), lithium tetrahydridogallate (LiGaH₄), potassium tetrahydridogallate (KGaH₄), lithium hydride (LiH), calcium hydride (CaH₂), magnesium hydride (MgH₂), or a mixture thereof.

Because the hydrogen generation reaction inside the dehydrogenation reactor 10 is an exothermic reaction, a cooling coil 19 is installed inside the reaction vessel 11 to discharge the reaction heat. A refrigerant may be circulated in the cooling coil 19 to cool heat generated by hydrolysis of the chemical hydride.

Referring back to FIG. 1 and FIG. 2, the acid aqueous solution tank 40 stores the acid aqueous solution and supplies the stored acid aqueous solution to the dehydrogenation reactor 10. An injection valve 17 is provided between the acid aqueous solution tank 40 and the dehydrogenation reactor 10, and a flow rate of the acid aqueous solution supplied to the dehydrogenation reactor 10 may be determined by an opening amount of the injection valve 17. To this end, the acid aqueous solution tank 40 and the dehydrogenation reactor 10 are fluidly connected.

A pump 41 is provided between the acid aqueous solution tank 40 and the dehydrogenation reactor 10, and the acid aqueous solution stored in the acid aqueous solution tank 40 is configured to be pumped by the pump 41 and supplied to the dehydrogenation reactor 10.

The acid aqueous solution tank 40 may be formed with a corrosion-resistant protective film such as a Teflon™ coating in order to prevent corrosion by the acid aqueous solution. The acid aqueous solution adjusts a pH of the chemical hydride to shorten a half-life thereof, thereby promoting the dehydrogenation reaction.

The acid may be an inorganic acid such as a sulfuric acid, a nitric acid, a phosphoric acid, a boric acid, or a hydrochloric acid, an organic acid such as a heteropoly acid, an acetic acid, a formic acid, a malic acid, a citric acid, a tartaric acid, an ascorbic acid, a lactic acid, an oxalic acid, a succinic acid, or a tauric acid, or a mixture thereof. In certain examples, formic acid (HCOOH) may be used, as it may reduce system weight, and because it is safer than a hydrochloric acid in a high concentration state.

The formic acid, as a weak acid, may be relatively safely used by being maintained at a low pH under the conditions described in the present disclosure. In addition, because the captured carbon dioxide may be obtained through hydrogenation, it is an important material in terms of re-utilizing/recycling of carbon dioxide. In addition, formate is converted to bicarbonate through a dehydrogenation reaction, in which case hydrogen may be additionally obtained.

The buffer tank 20 is configured to temporarily store the hydrogen generated in the dehydrogenation reaction apparatus 1, and as necessary, the hydrogen stored in the buffer tank 20 is configured to be supplied to a fuel cell 30. To this end, the buffer tank 20 and the dehydrogenation reactor 10 are fluidly connected.

A back pressure regulator 23 is provided between the buffer tank 20 and the dehydrogenation reactor 10, and when an inner pressure of the dehydrogenation reactor 10 increases to a predetermined pressure or more, hydrogen is configured to be supplied to the buffer tank 20.

An amount of hydrogen that may be stored in the buffer tank 20 may be set equal to a total amount of hydrogen generated in one reaction chamber 16 partitioned by the partition wall 15.

The buffer tank 20 is provided with a pressure sensor 21 that is configured to measure the inner pressure of the buffer tank 20, and the inner pressure of the buffer tank 20 measured by the pressure sensor 21 is configured to be transmitted to a controller 50.

The hydrogen temporarily stored in the buffer tank 20 is configured to be supplied to the fuel cell 30. To this end, the buffer tank 20 and the fuel cell 30 are fluidly connected. A mass flow meter 25 is disposed between the buffer tank 20 and the fuel cell 30 to control the flow of the hydrogen supplied to the fuel cell 30.

On the other hand, the dehydrogenation reaction apparatus 1 according to the embodiment may further include the controller 50 that is configured to control the acid aqueous solution supplied to the dehydrogenation reactor 10 based on a use rate of hydrogen consumed in the fuel cell 30 and the inner pressure of the buffer tank 20.

To this end, the controller 50 may be provided as at least one processor executed by a predetermined program, and the predetermined program is configured to perform respective acts of a control method of the dehydrogenation reaction apparatus 1 according to the embodiment.

The controller 50 may control the injection valve 17 provided between the acid aqueous solution tank 40 and the dehydrogenation reactor 10 to selectively supply the acid aqueous solution to the dehydrogenation reactor 10.

Only when the inner pressure of the buffer tank 20 is equal to or lower than a predetermined pressure, the controller 50 is configured to supply the acid aqueous solution to the dehydrogenation reactor 10. That is, when the inner pressure of the buffer tank 20 is lower than the predetermined pressure, the acid aqueous solution is not supplied to the dehydrogenation reactor 10.

When the rate of use of the hydrogen consumed in the fuel cell 30 is equal to or lower than the rate of generation of the hydrogen generated in one reaction chamber 16, the controller 50 is configured to supply an acid aqueous solution to one reaction chamber 16. Meanwhile, when the rate of use of the hydrogen consumed in the fuel cell 30 exceeds the rate of generation of the hydrogen generated in one reaction chamber 16, the controller 50 is configured to supply an acid aqueous solution to the plurality of reaction chambers 16.

Hereinafter, a control method of the dehydrogenation reaction apparatus 1 according to the embodiment above is described in detail with reference to the accompanying drawings.

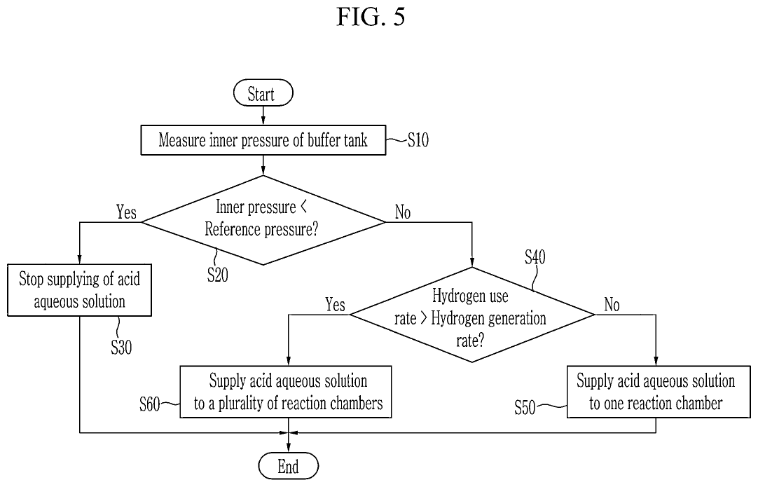

FIG. 5 illustrates a flowchart of a control method of the dehydrogenation reaction apparatus according to the embodiment.

As shown in FIG. 5, the pressure sensor 21 measures the inner pressure of the buffer tank 20, and the inner pressure of the buffer tank 20 measured by the pressure sensor 21 is transmitted to the controller 50 (S10).

The controller 50 determines whether the inner pressure of the buffer tank 20 is lower than the reference pressure (S20).

When the inner pressure of the buffer tank 20 is equal to or higher than the reference pressure, the controller 50 does not supply the acid aqueous solution to the dehydrogenation reactor 10 (S30). When the inner pressure of the buffer tank 20 is equal to or higher than the reference pressure, hydrogen is not generated in the dehydrogenation reactor 10 because it means that an amount of the hydrogen charged (or stored) in the buffer tank 20 is sufficient.

When the inner pressure of the buffer tank 20 is lower than the reference pressure, the controller 50 compares a hydrogen use rate used in the fuel cell 30 (for example, an amount of hydrogen consumed per unit time) and a rate of generation of hydrogen generated in one reaction chamber 16 partitioned by the partition wall 15 (for example, an amount of hydrogen generated per unit time) (S40).

When the hydrogen use rate is equal to or less than the hydrogen generation rate, the controller 50 supplies an acid aqueous solution to one reaction chamber 16. In this case, the controller 50 supplies the acid aqueous solution until all the hydrides stored in one reaction chamber 16 react (S50).

When the hydrogen use rate is greater than the hydrogen generation rate, the controller 50 supplies an acid aqueous solution to the plurality of reaction chambers 16 (for example, two reaction chambers 16) (S60). In this case, the controller 50 supplies the acid aqueous solution until all the hydrides stored in the plurality of reaction chambers 16 react.

When the inner pressure of the buffer tank 20 is lower than the reference pressure, since it means that the hydrogen capacity charged in the buffer tank 20 is not sufficient, it is required to fill the buffer tank 20. The number of the reaction chambers 16 for supplying an acid aqueous solution is determined by comparing the use rate of the hydrogen consumed in the fuel cell 30 and the generation rate of the hydrogen generated in one reaction chamber 16.

Then, the acid aqueous solution is supplied to the dehydrogenation reactor 10 until all the hydrides stored in one reaction chamber 16 react.

In this case, the hydrogen generated in the dehydrogenation reactor 10 is temporarily stored in the buffer tank 20 and then supplied to the fuel cell 30, and the capacity of the buffer tank 20 is set to be equal to the capacity of the hydrogen generated in one reaction chamber 16.

Through this process, the pressure of the buffer tank 20 for supplying hydrogen to the fuel cell 30 may be maintained at a predetermined pressure or higher, thereby stably maintaining the amount of hydrogen supplied to the fuel cell 30.

When the inside of the dehydrogenation reactor 10 is not partitioned into a plurality of reaction chambers 16 by the partition wall 15, the operation of the fuel cell 30 is temporarily stopped and then restarted, the hydrogen conversion rate of the hydride decreases.

The hydrogen conversion rate of the hydride stored inside the dehydrogenation reactor 10 through an experiment is described as follows.

When the dehydrogenation reactor 10 is restarted after 50% of the hydride stored in the dehydrogenation reactor 10 is reacted, the hydrogen conversion rate of the entire hydride becomes up to 91%. When the dehydrogenation reactor 10 is restarted after 70% of the hydride stored in the dehydrogenation reactor 10 is reacted, the hydrogen conversion rate of the entire hydride becomes up to 88.5%. When the dehydrogenation reactor 10 is restarted after 75% of the hydride stored in the dehydrogenation reactor 10 is reacted, the hydrogen conversion rate of the entire hydride becomes up to 76.5%. When all the hydrides stored in the dehydrogenation reactor 10 are continuously reacted, the hydrogen conversion rate of the entire hydride becomes 98.5%.

As described above, when the operation of the dehydrogenation reactor 10 is temporarily stopped and then restarted, the hydrogen conversion rate is significantly lower than the hydrogen conversion rate by the continuous reaction of hydride.

According to the embodiment, by partitioning the dehydrogenation reactor 10 into the plurality of reaction chambers 16 by using the partition wall 15, and by reacting all the hydrides stored in one reaction chamber 16, it is possible to maintain the hydrogen conversion rate of the hydride at a high level.

In addition, by introducing the buffer tank 20 that may store the amount of the hydrogen generated in one reaction chamber 16, it is possible to stably supply hydrogen to the fuel cell 30 that uses hydrogen.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1: dehydrogenation reaction apparatus
10: dehydrogenation reactor
11: reaction vessel
12: first supply port
13: second supply port
14: gas outlet
15: partition wall
16: reaction chamber
17: injection valve
19: cooling coil
20: buffer tank
21: pressure sensor
23: back pressure regulator
25: mass flow meter
30: fuel cell
40: acid aqueous solution tank
41: pump
90: controller

What is claimed is:

1. A dehydrogenation reaction apparatus comprising:
a dehydrogenation reactor having a reaction vessel configured to store a chemical hydride, and at least one partition wall partitioning an inner space of the reaction vessel into a plurality of reaction chambers; and
a buffer tank configured to temporarily store hydrogen generated in the dehydrogenation reactor and supply the hydrogen to a fuel cell.

2. The dehydrogenation reaction apparatus of claim 1, wherein the dehydrogenation reactor further comprises:
a first supply port formed in the reaction vessel and configured to supply an acid aqueous solution to each reaction chamber of the plurality of reaction chambers;
a second supply port formed in the reaction vessel and configured to supply the chemical hydride to each reaction chamber of the plurality of reaction chambers; and
a gas outlet formed in the reaction vessel and configured to discharge hydrogen generated in each reaction chamber of the plurality of reaction chambers.

3. The dehydrogenation reaction apparatus of claim 1, further comprising:
a cooling coil installed inside the reaction vessel, wherein the cooling coil is configured to circulate a refrigerant.

4. The dehydrogenation reaction apparatus of claim 1, further comprising:
a back pressure regulator disposed between the dehydrogenation reactor and the buffer tank.

5. The dehydrogenation reaction apparatus of claim 1, further comprising:
a mass flow meter disposed between the buffer tank and the fuel cell.

6. The dehydrogenation reaction apparatus of claim 1, further comprising:
an acid aqueous solution tank configured to store an acid aqueous solution; and
a pump configured to pump the acid aqueous solution stored in the acid aqueous solution tank to the dehydrogenation reactor.

7. The dehydrogenation reaction apparatus of claim 6, further comprising:
a controller configured to adjust the acid aqueous solution supplied to the dehydrogenation reactor based on a use rate of hydrogen consumed in the fuel cell and an inner pressure of the buffer tank.

8. The dehydrogenation reaction apparatus of claim 7, wherein the controller is configured to supply the acid aqueous solution to the dehydrogenation reactor only when the inner pressure of the buffer tank is less than a reference pressure.

9. The dehydrogenation reaction apparatus of claim 8, wherein the controller is configured to supply the acid aqueous solution to one reaction chamber when the use rate of the hydrogen consumed in the fuel cell is less than or equal to a generation rate of the hydrogen generated in the reaction chamber.

10. The dehydrogenation reaction apparatus of claim 8, wherein the controller is configured to supply the acid aqueous solution to the plurality of reaction chambers when the use rate of the hydrogen consumed in the fuel cell exceeds a generation rate of the hydrogen generated in the reaction chamber.

11. The dehydrogenation reaction apparatus of claim 1, wherein an amount of hydrogen stored in the buffer tank is set to be equal to a total amount of hydrogen generated in one reaction chamber of the plurality of reaction chambers.

12. A control method of a dehydrogenation reaction apparatus, the control method comprising:
providing the dehydrogenation reaction apparatus comprising: a dehydrogenation reactor having a reaction vessel storing a chemical hydride, and at least one partition wall partitioning an inner space of the reaction vessel into a plurality of reaction chambers; and a buffer tank temporarily storing hydrogen generated in the dehydrogenation reactor;
measuring an inner pressure of the buffer tank;
comparing a use rate of hydrogen consumed in a fuel cell with a generation rate of hydrogen generated in a reaction chamber of the plurality of reaction chambers when the inner pressure of the buffer tank is less than a reference pressure; and
supplying an acid aqueous solution to one reaction chamber or a plurality of the reaction chambers based on the use rate of the hydrogen and the generation rate of the hydrogen.

13. The control method of claim 12, further comprising:
supplying the acid aqueous solution to one reaction chamber of the plurality of reaction chambers when the use rate of the hydrogen is less than or equal to the generation rate of the hydrogen.

14. The control method of claim 12, further comprising:
supplying the acid aqueous solution to the plurality of the reaction chambers when the use rate of the hydrogen exceeds the generation rate of the hydrogen.

15. The control method of claim 12, further comprising:
supplying the acid aqueous solution until all of the chemical hydride in the reaction chamber react.
